(19) United States
(12) Patent Application Publication
(10) Pub. No.: US 2021/0227429 A1
(43) Pub. Date: Jul. 22, 2021

(54) MEASUREMENT METHOD, DEVICE, SYSTEM, AND STORAGE MEDIUM

(71) Applicant: BEIJING XIAOMI MOBILE SOFTWARE CO., LTD., Beijing (CN)

(72) Inventor: Yajun ZHU, Beijing (CN)

(73) Assignee: BEIJING XIAOMI MOBILE SOFTWARE CO., LTD., Beijing (CN)

(21) Appl. No.: 17/053,942

(22) PCT Filed: Jun. 1, 2018
(86) PCT No.: PCT/CN2018/089655

§ 371 Date: Nov. 9, 2020

(51) Int. Cl. H04W 36/00; H04W 36/32

(52) U.S. Cl. CPC H04W 36/0058; H04W 36/00837; H04W 36/32; H04W 36/0094

(57) ABSTRACT

Aspects of the disclosure provide a measurement method, device, system and storage medium, belonging to the technical field of wireless communications. The measurement method can include receiving status information sent by user equipment (UE), and, according to the status information sent by the UE, sending measurement instruction information to the UE, wherein the measurement instruction information is used for instructing the UE to perform measurement. The measurement method can be used to improve measurement ability of UE.

### RELATED APPLICATION

This application claims the benefit of International Application No. PCT/CN2018/089655, entitled “Measurement Method, Device, System, and Storage Medium” and filed on Jun. 1, 2018, which is incorporated herein by reference in its entirety.

### TECHNICAL FIELD

The subject disclosure relates to the field of wireless communication, including to a measurement method, device, and system, and a storage medium.

### BACKGROUND

In a wireless communication system, when User Equipment (UE) may move from a range covered by a cell currently accessed by the UE to a range covered by another cell, the UE may have to be switched in order to guarantee continuity of a communication service. By switching UE, it means that the UE is disconnected from the base station (BS) managing the cell currently accessed, and is connected to the base station managing another cell. In order to guarantee that the UE is switched to a cell better than the cell currently accessed by the UE, the UE may have to perform measurement on the cell currently accessed by the UE and a neighbor cell neighboring the UE. Accordingly, the base station may switch the UE based on a result of measurement.

In related art, UE may perform measurement on a cell currently accessed by the UE and a neighbor cell neighboring the UE according to a fixed measurement frequency. When the result of measurement meets a condition, the UE may send a measurement report to the base station. Accordingly, the base station may switch the UE based on the measurement report. However, such a mode of measurement is not flexible.

### SUMMARY

Embodiments herein provide a measurement method, device, and system, and a storage medium, capable of improving flexibility of measurement by UE.

According to a first aspect herein, a measurement method can include receiving status information sent by User Equipment (UE), and sending measurement instruction information to the UE according to the status information sent by the UE. The measurement instruction information is for instructing the UE to perform measurement according to the measurement instruction information.

Optionally, the status information may be for indicating at least one of a movement status of the UE and a channel status of the UE. Further, the measurement instruction information may be for trigger of measurement by the UE.

The measurement instruction information may be for instructing the UE to adjust a measurement frequency, and perform measurement according to an adjusted measurement frequency.

In an embodiment, the method may further include sending first report instruction information to the UE according to the status information sent by the UE. The first report instruction information may be for instructing the UE to adjust a result sending frequency for sending a result of measurement to a base station, and send the result of measurement to the base station according to an adjusted result sending frequency.

Optionally, the method may further include sending second report instruction information to the UE according to the status information sent by the UE. The second report instruction information may be for instructing the UE to adjust a status sending frequency for sending the status information to a base station, and send the status information to the base station according to an adjusted status sending frequency.

According to a second aspect herein, a measurement method can include sending status information to a base station. Further, the method can include receiving measurement instruction information sent by the base station according to the status information, and performing measurement according to the measurement instruction information.

Optionally, the status information may be for indicating at least one of a movement status of User Equipment (UE) and a channel status of the UE.

Optionally, performing measurement according to the measurement instruction information may include starting to perform measurement as triggered by the measurement instruction information. Further, performing measurement according to the measurement instruction information may include adjusting a measurement frequency as instructed by the measurement instruction information, and performing measurement according to an adjusted measurement frequency.

In an embodiment, the method may further include receiving first report instruction information sent by the base station according to the status information, and adjusting a result sending frequency for sending a result of measurement to the base station as instructed by the first report instruction information. Further, the method can include sending the result of measurement to the base station according to an adjusted result sending frequency.

Optionally, the method may further include receiving second report instruction information sent by the base station according to the status information, and adjusting a status sending frequency for sending the status information to the base station as instructed by the second report instruction information. Further, the method can include sending the status information to the base station according to an adjusted status sending frequency.

According to a third aspect herein, a measurement device includes a receiving module and a first sending module. The receiving module is adapted to receiving status information sent by User Equipment (UE). The first sending module is adapted to sending measurement instruction information to the UE according to the status information sent by the UE. The measurement instruction information is for instructing the UE to perform measurement according to the measurement instruction information.

Optionally, the status information may be for indicating at least one of a movement status of the UE and a channel status of the UE.

The measurement instruction information may be for trigger of measurement by the UE. Further, the measurement instruction information may be for instructing the UE to adjust a measurement frequency, and perform measurement according to an adjusted measurement frequency.

Additionally, the device may further include a second sending module. The second sending module may be adapted to sending first report instruction information to the UE according to the status information sent by the UE. The first report instruction information may be for instructing the UE to adjust a result sending frequency for sending a result of measurement to a base station, and send the result of measurement to the base station according to an adjusted result sending frequency.

Optionally, the device may further include a third sending module. The third sending module may be adapted to sending second report instruction information to the UE according to the status information sent by the UE. The second report instruction information may be for instructing the UE to adjust a status sending frequency for sending the status information to a base station, and send the status information to the base station according to an adjusted status sending frequency.

According to a fourth aspect herein, a measurement device includes a first sending module, a first receiving module, and a measurement module. The first sending module is adapted to sending status information to a base station. The first receiving module is adapted to receiving measurement instruction information sent by the base station according to the status information. The measurement module is adapted to performing measurement according to the measurement instruction information.

Optionally, the status information may be for indicating at least one of a movement status of User Equipment (UE) and a channel status of the UE.

Further, the measurement module may be adapted to starting to perform measurement as triggered by the measurement instruction information.

Optionally, the measurement module may be adapted to adjusting a measurement frequency as instructed by the measurement instruction information, and performing measurement according to an adjusted measurement frequency.

The device may further include a second receiving module, a first adjustment module, and a second sending module. The second receiving module may be adapted to receiving first report instruction information sent by the base station according to the status information. The first adjustment module may be adapted to adjusting a result sending frequency for sending a result of measurement to the base station as instructed by the first report instruction information. The second sending module may be adapted to sending the result of measurement to the base station according to an adjusted result sending frequency.

Optionally, the device may further include a third receiving module, a second adjustment module, and a third sending module. The third receiving module may be adapted to receiving second report instruction information sent by the base station according to the status information. The second adjustment module may be adapted to adjusting a status sending frequency for sending the status information to the base station as instructed by the second report instruction information. The third sending module may be adapted to sending the status information to the base station according to an adjusted status sending frequency.

According to a fifth aspect herein, a base station includes a processor and memory. The memory is adapted to storing an instruction executable by the processor. The processor is adapted to perform operations that can include receiving status information sent by User Equipment (UE), and sending measurement instruction information to the UE according to the status information sent by the UE. The measurement instruction information is for instructing the UE to perform measurement according to the measurement instruction information.

According to a sixth aspect herein, user equipment includes a processor and memory. The memory is adapted to storing an instruction executable by the processor. The processor is adapted to perform operations that can include sending status information to a base station, receiving measurement instruction information sent by the base station according to the status information, and performing measurement according to the measurement instruction information.

According to a seventh aspect herein, a measurement system includes a measurement device of the third aspect herein and a measurement device of the fourth aspect herein.

According to an eighth aspect herein, a non-transitory computer readable storage medium has stored thereon a computer program which, when executed by a processing component, implements a measurement method of the first aspect herein, or a measurement method of the second aspect herein.

A technical solution herein may include beneficial effects. For example, a base station can receive status information sent by UE. The base station sends measurement instruction information to the UE according to the status information sent by the UE. Accordingly, the UE may perform measurement according to the measurement instruction information. As a result, the base station may control, according to the status of the UE, measurement by the UE, thereby improving flexibility of measurement by the UE.

The above general description and detailed description below are but exemplary and explanatory, and do not limit the subject disclosure.

### BRIEF DESCRIPTION OF THE ACCOMPANYING DRAWINGS

Drawings here are incorporated in and constitute part of the subject disclosure, illustrate exemplary embodiments according to the subject disclosure, and together with the subject disclosure, serve to explain the principle of the subject disclosure.

FIG. 1 is a diagram of an implementation environment according to an exemplary embodiment.

FIG. 2 is a flowchart of a measurement method according to an exemplary embodiment.

FIG. 3 is a flowchart of a measurement method according to an exemplary embodiment.

FIG. 4 is a flowchart of a measurement method according to an exemplary embodiment.

FIG. 5 is a diagram of a location of UE according to an exemplary embodiment.

FIG. 6 is a diagram of a location of UE according to an exemplary embodiment.

FIG. 7 is a block diagram of a measurement device according to an exemplary embodiment.

FIG. 8 is a block diagram of a measurement device according to an exemplary embodiment.

FIG. 9 is a block diagram of a measurement device according to an exemplary embodiment.

FIG. 10 is a block diagram of a measurement device according to an exemplary embodiment.

FIG. 11 is a block diagram of a measurement device according to an exemplary embodiment.

FIG. 12 is a block diagram of a measurement device according to an exemplary embodiment.

FIG. 13 is a block diagram of a measurement system according to an exemplary embodiment.

### DETAILED DESCRIPTION

To clearly show a technical problem to be solved, a technical solution, and beneficial effects herein, the subject disclosure is further elaborated below with reference to the drawings and embodiments.

Exemplary embodiments, examples of which are illustrated in the accompanying drawings, are elaborated below. The following description may refer to the accompanying drawings, in which identical or similar elements in two drawings are denoted by identical reference numerals unless indicated otherwise. Implementations set forth in the following exemplary embodiments do not represent all implementations in accordance with the subject disclosure. Rather, they are mere examples of the device (i.e., device/equipment/terminal) and method in accordance with certain aspects of the subject disclosure as recited in the accompanying claims.

In order to guarantee continuity of a communication service, User Equipment (UE) may have to be switched when moving from a range covered by a cell currently accessed by the UE to a range covered by another cell. In order to achieve switching, the UE may have to perform measurement on both the cell currently accessed by the UE and a neighbor cell. Accordingly, a base station may switch the UE based on a result of measurement.

In related art, the UE may perform measurement on the cell currently accessed by the UE and the neighbor cell neighboring the UE according to a fixed measurement frequency.

However, in some cases, it is highly impossible that the UE may have to be switched. In this case, performing measurement by the UE according to the fixed measurement frequency may lead to waste of energy of the UE. In other cases, it is highly possible that the UE may have to be switched. In this case, performing measurement by the UE according to the fixed frequency may cause the UE to fail to send a measurement report to the base station in time, thereby impacting efficiency in switching. Therefore, in related art, the UE may not be able to perform measurement flexibly.

With a measurement method according to an embodiment herein, UE may perform measurement more flexibly. With the measurement method, the UE may send status information, i.e., information on a status of the UE to a base station. The base station may receive the status information, and then send measurement instruction information to the UE according to the status information. The UE may receive the measurement instruction information, and then perform measurement according to the measurement instruction information. Accordingly, the base station may control, according to the status of the UE, measurement by the UE. For example, the base station may control a measurement frequency for measurement by the UE, thereby improving flexibility of measurement by the UE.

Hereinafter, an implementation environment for implementing a measurement method herein is described below.

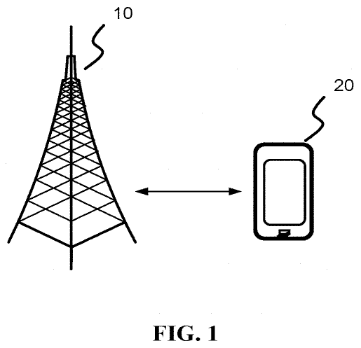

FIG. 1 is a diagram of an implementation environment for implementing a measurement method herein. As shown in FIG. 1, the implementation environment may include a base station 10 and UE 20. The base station 10 and the UE 20 may be connected by a communication network. The UE 20 may be any UE served in a cell served by the base station 10. The communication network may be a Fifth Generation Mobile Communication Technology (5G) communication network, a Long Term Evolution (LTE) communication network, another communication network similar to the LTE communication network or the 5G communication network, etc.

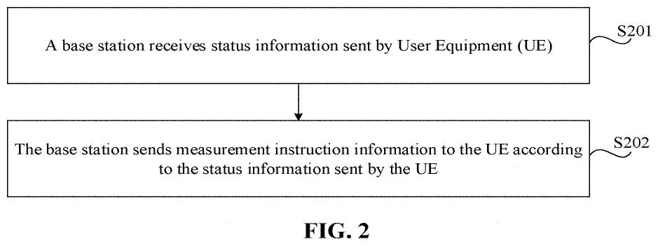

FIG. 2 is a flowchart of a measurement method according to an exemplary embodiment. As shown in FIG. 2, the measurement method is applicable to the base station 10 shown in FIG. 1. The measurement method may include the following steps.

In step S201, a base station receives status information sent by User Equipment (UE).

In step S202, the base station sends measurement instruction information to the UE according to the status information sent by the UE. The measurement instruction information is for instructing the UE to perform measurement according to the measurement instruction information.

To sum up, with a measurement method herein, a base station receives status information sent by UE. The base station sends measurement instruction information to the UE according to the status information sent by the UE. Accordingly, the UE may perform measurement according to the measurement instruction information. As a result, the base station may control, according to the status of the UE, measurement by the UE, thereby improving flexibility of measurement by the UE.

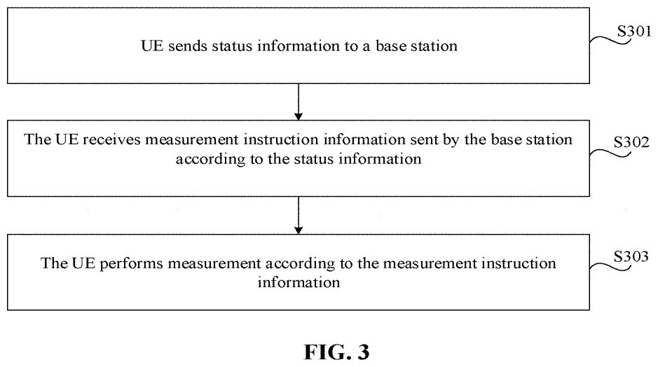

FIG. 3 is a flowchart of a measurement method according to an exemplary embodiment. As shown in FIG. 3, the measurement method is applicable to the UE 20 shown in FIG. 1. The measurement method may include the following steps.

In step S301, UE sends status information to a base station.

In step S302, the UE receives measurement instruction information sent by the base station according to the status information.

In step S303, the UE performs measurement according to the measurement instruction information.

To sum up, with a measurement method herein, UE sends status information to a base station. Then, the base station may return measurement instruction information to the UE according to the status information. The UE performs measurement according to the measurement instruction information. As a result, the base station may control, according to the status of the UE, measurement by the UE, thereby improving flexibility of measurement by the UE.

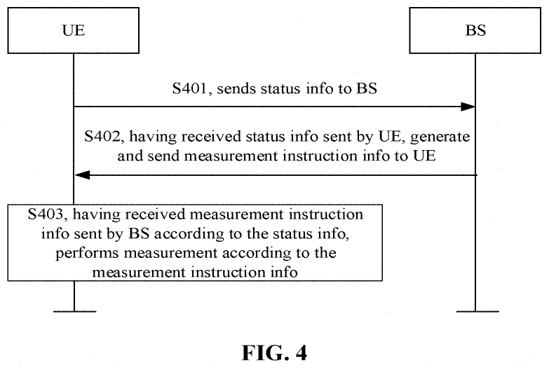

FIG. 4 is a flowchart of a measurement method according to an exemplary embodiment. As shown in FIG. 4, the measurement method is applicable to the implementation environment shown in FIG. 1. The measurement method may include the following steps.

In step S401, UE sends status information to a base station. The status information may be for indicating at least one of a movement status of the UE and a channel status of the UE. The movement status of the UE may include at least one of a status of a location of the UE, a status of a speed of the UE, and the like. The channel status of the UE may include a status of quality of a channel of the UE.

According to an embodiment herein, the status information may include at least one of geographic location information, movement speed information, and channel quality information. The geographic location information may be for indicating the status of the location of the UE. The movement speed information may be for indicating the status of the speed of the UE. The channel quality information may be for indicating the status of quality of the channel of the UE.

Optionally, the geographic location information may indicate a current geographic location of the UE, or an offset value of the current geographic location of the UE compared to a geographic location indicated by geographic location information reported by the UE to the base station last time.

In general, the movement status of the UE and the channel status of the UE may be closely related to the possibility that the UE may have to be switched. For example, when the UE is moving at a high speed, the UE may be on a vehicle. In such a case, it is highly possible that the UE may move from a range covered by a cell currently accessed by the UE to a range covered by another cell within a short time. Accordingly, it is highly possible that the UE may have to be switched. On the other hand, when the UE is moving at a low speed, the UE may be still, or may be on a user who is walking. In such a case, it is highly impossible that the UE may move from a range covered by a cell currently accessed by the UE to a range covered by another cell within a short time. Accordingly, it is highly impossible that the UE may have to be switched.

As another example, the UE may be located at a location covered by multiple cells. Then, it is highly possible that the UE may move gradually from a range covered by a cell currently accessed by the UE among the multiple cells, to a range covered by another cell. Accordingly, it is highly possible that the UE may have to be switched. On the other hand, the UE may be located at a location covered by one cell. Then, it is highly impossible that the UE may move from a range covered by a cell currently accessed by the UE to a range covered by another cell. Accordingly, it is highly impossible that the UE may have to be switched.

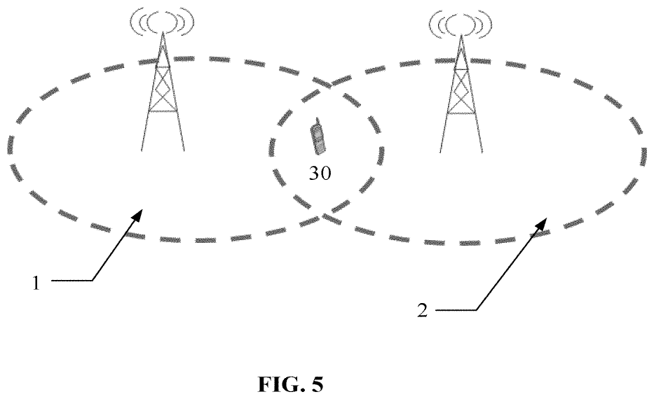

As shown in FIG. 5, UE 30 may be located at a location covered by both cells. The two cells are cell 1 and cell 2, respectively. Cell 1 is currently accessed by the UE 30. As shown in FIG. 5, it is highly possible that the UE 30 gradually moves from a range covered by the cell 1 to a range covered by the cell 2. Accordingly, it is highly possible that the UE 30 may have to be switched.

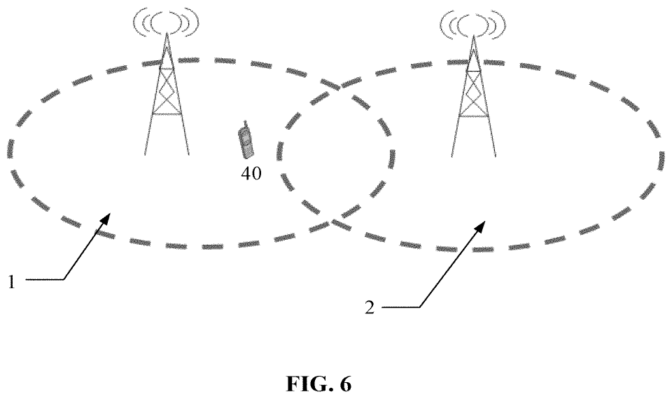

As shown in FIG. 6, UE 40 may be located in a range covered by one cell, i.e., cell 1. Cell 1 is currently accessed by the UE. As shown in FIG. 6, it is unlikely that the UE 40 may move from a range covered by the cell 1 to a range covered by another cell (namely cell 2). Accordingly, it is unlikely that the UE 30 may have to be switched.

As another example, the channel of the UE may be of poor quality. Then, it may mean that the UE is leaving a range covered by a cell currently accessed by the UE. Therefore, in such a case, it is highly possible that the UE may have to be switched. On the other hand, the channel of the UE may be of excellent quality. Then, it may mean that it is unlikely that the UE is leaving a range covered by a cell currently accessed by the UE. Therefore, in such a case, it is highly impossible that the UE may have to be switched.

The movement status of the UE and the channel status of the UE may be closely related to the possibility that the UE may have to be switched. Therefore, according to an embodiment herein, UE may send, to a base station, status information for indicating at least one of the movement status of the UE and the channel status of the UE. Accordingly, the base station may control, according to the status information, measurement by the UE. For example, the base station may control a measurement frequency for measurement by the UE, thereby improving flexibility of measurement by the UE.

According to an exemplary embodiment herein, the UE may send the status information to the base station at a status sending frequency. For example, the UE may send the status information to the base station every three sub-frames. According to an embodiment herein, a measurement method herein is described taking as an example one sending of the status information to the base station by the UE.

In step 402, having received status information sent by the UE, the BS may generate and send measurement instruction info to the UE. The measurement instruction information is for instructing the UE to perform measurement according to the measurement instruction information. According to an embodiment herein, the measurement instruction information may be for trigger of measurement by the UE. Alternatively, the measurement instruction information may be for instructing the UE to adjust a measurement frequency, and perform measurement according to an adjusted measurement frequency. A measurement frequency may be adjusted by being increased or by being decreased.

For ease of description, measurement instruction information for trigger of measurement by the UE may be referred to as measurement trigger information hereinafter. Measurement instruction information for instructing the UE to increase the measurement frequency may be referred to as measurement frequency increasing information. Measurement instruction information for instructing the UE to decrease the measurement frequency may be referred to as measurement frequency decreasing information.

Optionally, when the status information sent by the UE to the base station is geographic location information, the base station may determine whether the UE is located in a range covered by at least two cells according to the geographic location information.

When the base station determines that the UE is located in the range covered by at least two cells according to the geographic location information sent by the UE, it may mean that it is highly possible that the UE may have to be switched. In such a case, the base station may send the measurement trigger information or the measurement frequency increasing information to the UE.

According to possible implementation, the UE may have performed no measurement before sending the status information to the base station. In such a case, when the base station determines that the UE is located in a range covered by at least two cells according to the geographic location information sent by the UE, the base station may send the measurement trigger information to the UE to trigger measurement by the UE.

Optionally, the measurement trigger information may be for indicating at least one of an identity of a cell on which measurement is to be performed by the UE and a parameter to be measured by the UE. A parameter to be measured by the UE may be Reference Signal Receiving Power (RSRP). The measurement trigger information may be for trigger of one measurement, or multiple periodic measurements, by the UE. When the measurement trigger information is for trigger multiple periodic measurements by the UE, the measurement trigger information may further instruct a measurement frequency for measurement by the UE.

According to possible implementation, the UE may have performed measurement before sending the status information to the base station. In such a case, when the base station determines that the UE is located in the range covered by at least two cells according to the geographic location information sent by the UE, the base station may send the measurement frequency increasing information to the UE to instruct the UE to increase the measurement frequency, thereby guaranteeing efficiency in switching the UE.

For example, before sending the status information to the base station, the UE may perform measurement every five sub-frames. When the base station determines that the UE is located in the range covered by at least two cells according to the geographic location information sent by the UE, the base station may send the measurement frequency increasing information to the UE. The measurement frequency increasing information may be for instructing the UE to increase the measurement frequency to perform measurement every three sub-frames.

When the base station determines that the UE is located in a range covered by one cell according to the geographic location information sent by the UE, it may mean that it is highly impossible that the UE may have to be switched. In such a case, the base station may send the measurement frequency decreasing information to the UE to instruct the UE to decrease the measurement frequency for measurement by the UE, thereby avoiding waste of energy of the UE, thereby increasing a standby time of the UE.

For example, before sending the status information to the base station, the UE may perform measurement every three sub-frames. When the base station determines that the UE is located in the range covered by the one cell according to the geographic location information sent by the UE, the base station may send the measurement frequency decreasing information to the UE. The measurement frequency decreasing information may be for instructing the UE to decrease the measurement frequency to perform measurement every five sub-frames.

In addition, according to an embodiment herein, when the base station determines that the UE is in the range covered by the one cell according to the geographic location information sent by the UE, the base station may further send measurement stopping information to the UE to instruct the UE to stop measurement, thereby further avoiding waste of energy of the UE, increasing a standby time of the UE.

Optionally, when the status information sent by the UE to the base station is movement speed information, the base station may determine, according to the movement speed information, whether a speed of the UE is within a range.

When the base station determines that the speed of the UE is greater than a first speed threshold, it may mean that it is highly possible that the UE may have to be switched. At such a time, the base station may send measurement trigger information to the UE. Similarly, the UE may have performed no measurement before sending the status information to the base station. The base station may determine, according to the movement speed information, that the speed of the UE is greater than the first speed threshold. Then, the base station may send the measurement trigger information to the UE.

When the base station determines that the speed of the UE is greater than a second speed threshold, it may mean that it is highly possible that the UE may have to be switched. In such a case, the base station may send measurement frequency increasing information to the UE.

When the base station determines, according to the movement speed information, that the speed of the UE is less than a third speed threshold, it may mean that it is highly impossible that the UE may have to be switched. In such a case, the base station may send measurement frequency decreasing information to the UE.

In addition, according to an embodiment herein, when the base station determines, according to the movement speed information, that the speed of the UE is less than the third speed threshold, the base station may further send measurement stopping information to the UE to instruct the UE to stop measurement, thereby further avoiding waste of energy of the UE, increasing a standby time of the UE.

The first speed threshold, the second speed threshold, and the third speed threshold may be specified by a communication protocol. In actual implementation, the first speed threshold, the second speed threshold, and the third speed threshold may or may not be equal, which are not limited to the embodiment herein.

Optionally, when the status information sent by the UE to the base station is channel quality information, the base station may determine, according to the channel quality information, whether quality of the channel of the UE is within a range.

When the base station determines, according to the channel quality information, that quality of the channel of the UE is lower than a first quality threshold, it may mean that it is highly possible that the UE may have to be switched. In such a case, the base station may send the measurement trigger information to the UE.

Similarly, the UE may have performed no measurement before sending the status information to the base station. The base station may determine, according to the channel quality information, that quality of the channel of the UE is lower than the first quality threshold. Then, the base station may send the measurement trigger information to the UE.

When the base station determines, according to the channel quality information, that quality of the channel of the UE is lower than a second quality threshold, it may mean that it is highly possible that the UE may have to be switched. In such a case, the base station may send the measurement frequency increasing information to the UE.

When the base station determines, according to the channel quality information, that quality of the channel of the UE is greater than a third quality threshold, it may mean that it is highly impossible that the UE may have to be switched. In such a case, the base station may send measurement frequency decreasing information to the UE.

In addition, according to an embodiment herein, when the base station determines, according to the channel quality information, that quality of the channel of the UE is greater than the third quality threshold, the base station may further send measurement stopping information to the UE to instruct the UE to stop measurement, thereby further avoiding waste of energy of the UE, increasing a standby time of the UE.

The first quality threshold, the second quality threshold, and the third quality threshold may be specified by a communication protocol. During actual implementation, the first quality threshold, the second quality threshold, and third quality threshold may or may not be equal, which are not limited to the embodiment herein.

In step 403, having received measurement instruction information sent by the BS according to the status information, the UE performs measurement according to the measurement instruction information. Optionally, when the measurement indication information received by the UE is measurement trigger information, the UE may perform measurement as triggered by the measurement trigger information.

Optionally, when measurement information received by the UE is measurement frequency increasing information, the UE may increase a measurement frequency as instructed by the measurement frequency increasing information, and perform measurement according to an increased measurement frequency.

Optionally, when measurement information received by the UE is measurement frequency decreasing information, the UE may decrease the measurement frequency as instructed by the measurement frequency decreasing information, and perform measurement according to a decreased measurement frequency.

As described above, the UE may send the status information to the base station at a status sending frequency. Meanwhile, the UE may report a result of measurement to the base station at a result sending frequency. In general, when the possibility that the UE may have to be switched is high, the UE may have to send the status information and the result of measurement to the base station more frequently. Accordingly, the base station can control the UE in time to perform measurement based on the status information, and can control in time to switch the UE according to the result of measurement, thereby improving efficiency in measurement by the UE. When it is highly impossible that the UE may have to be switched, the UE may have to send the status information and the result of measurement to the base station less frequently, thereby reducing energy consumption of the UE, increasing a standby time of the UE.

To this end, after receiving the status information sent by the UE, the base station may generate first report instruction information and second report instruction information according to the status information, and send the first report instruction information and the second report instruction information to the UE. The first report instruction information may be for instructing the UE to adjust a result sending frequency for sending the result of measurement to the base station, and send the result of measurement to the base station according to an adjusted result sending frequency. The second report instruction information may be for instructing the UE to adjust a status sending frequency for sending the status information to the base station, and send the status information to the base station according to an adjusted status sending frequency.

A sending frequency may be adjusted by being increased or decreased. For example, the status sending frequency may be adjusted as follows.

The UE may currently send status information to the base station every three sub-frames. When the UE decreases the status sending frequency as instructed by the second report instruction information, the UE may send the status information to the base station every five sub-frames.

The UE may currently send status information to the base station every five sub-frames. When the UE increases the status sending frequency as instructed by the second report instruction information, the UE may send the status information to the base station every three sub-frames.

According to an embodiment herein, when the base station determines that the UE is located in a range covered by at least two cells according to geographic location information sent by the UE, the base station may instruct, through the first report instruction information, the UE to increase the result sending frequency for sending a result of measurement, and/or instruct, through the second report instruction information, the UE to increase the status sending frequency for sending status information. When the base station determines, according to the geographic location information sent by the UE, that the UE is located in a range covered by one cell, the base station may instruct, through the first report instruction information, the UE to decrease the result sending frequency for sending the result of measurement, and/or instruct, through the second report instruction information, the UE to decrease the status sending frequency for sending status information.

According to an embodiment herein, when the base station determines, according to the movement speed information, that a speed of the UE is greater than a fourth speed threshold, the base station may instruct, through the first report instruction information, the UE to increase the result sending frequency for sending the result of measurement, and/or instruct, through the second report instruction information, the UE to increase the status sending frequency for sending the status information. When the base station determines, according to the movement speed information, that the speed of the UE is less than a fifth speed threshold, the base station may instruct, through the first report instruction information, the UE to decrease the result sending frequency for sending the result of measurement, and/or instruct, through the second report decrease information, the UE to decrease the status sending frequency for sending the status information.

The fourth speed threshold and the fifth speed threshold may be specified by a communication protocol. The fourth speed threshold and the fifth speed threshold may or may not be equal, which are not limited to the embodiment herein.

According to an embodiment herein, when the base station determines, according to the channel quality information, that quality of the channel of the UE is lower than a fourth quality threshold, the base station may instruct, through the first report instruction information, the UE to increase the result sending frequency for sending the result of measurement, and/or instruct, through the second report instruction information, the UE to increase the status sending frequency for sending the status information. When the base station determines, according to the channel quality information, that quality of the channel of the UE is higher than the fifth quality threshold, the base station may instruct, through the first report instruction information, the UE to decrease the result sending frequency for sending the result of measurement, and/or instruct, through the second report instruction information, the UE to decrease the status sending frequency for sending the status information.

The fourth quality threshold and the fifth quality threshold may be specified by a communication protocol. The fourth quality threshold and the fifth quality threshold may or may not be equal, which are not limited to the embodiment herein.

To sum up, with a measurement method herein, a base station receives status information sent by UE. The base station sends measurement instruction information to the UE according to the status information sent by the UE. Accordingly, the UE may perform measurement according to the measurement instruction information. As a result, the base station may control, according to the status of the UE, measurement by the UE, thereby improving flexibility of measurement by the UE.

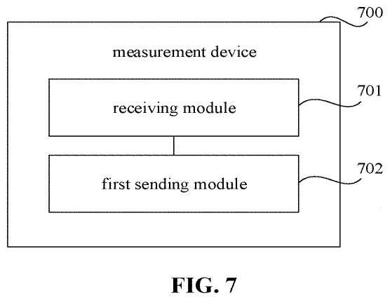

FIG. 7 is a block diagram of a measurement device 700 according to an exemplary embodiment. The measurement device 700 may be arranged in the base station 10 shown in FIG. 1. Referring to FIG. 7, the measurement device 700 may include a receiving module 701 and a first sending module 702. Of course, it should be understood that one or more of the modules described in this disclosure can be implemented by processing circuitry.

The receiving module 701 is adapted to receiving status information sent by User Equipment (UE).

The first sending module 702 is adapted to sending measurement instruction information to the UE according to the status information sent by the UE. The measurement instruction information is for instructing the UE to perform measurement according to the measurement instruction information.

According to an embodiment herein, the status information may be for indicating at least one of a movement status of the UE and a channel status of the UE.

According to another embodiment herein, the measurement instruction information may be for trigger of measurement by the UE.

According to a further embodiment herein, the measurement instruction information may be for instructing the UE to adjust a measurement frequency, and perform measurement according to an adjusted measurement frequency.

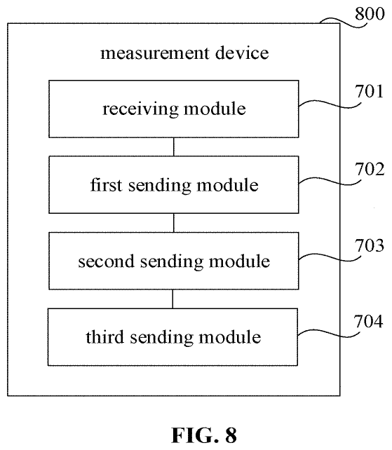

As shown in FIG. 8, an embodiment herein further provides another measurement device 800. In addition to the modules included in the measurement device 700, the measurement device 800 may further include a second sending module 703 and a third sending module 704.

The second sending module 703 may be adapted to sending first report instruction information to the UE according to the status information sent by the UE. The first report instruction information may be for instructing the UE to adjust a result sending frequency for sending a result of measurement to a base station, and send the result of measurement to the base station according to an adjusted result sending frequency.

The third sending module 704 may be adapted to sending second report instruction information to the UE according to the status information sent by the UE. The second report instruction information may be for instructing the UE to adjust a status sending frequency for sending the status information to a base station, and send the status information to the base station according to an adjusted status sending frequency.

To sum up, with a measurement device herein, a base station receives status information sent by UE. The base station sends measurement instruction information to the UE according to the status information sent by the UE. Accordingly, the UE may perform measurement according to the measurement instruction information. As a result, the base station may control, according to the status of the UE, measurement by the UE, thereby improving flexibility of measurement by the UE.

A module of the device according to at least one embodiment herein may perform an operation in a mode elaborated in at least one embodiment of the method herein, which will not be repeated here.

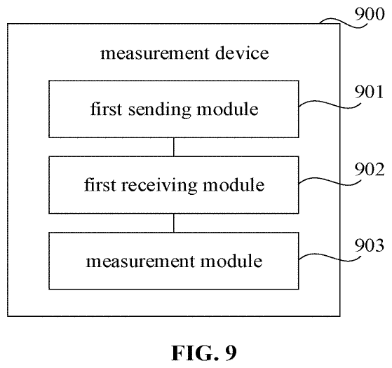

FIG. 9 is a block diagram of a measurement device 900 according to an exemplary embodiment. The measurement device 900 may be arranged in the UE 20 shown in FIG. 1. With reference to FIG. 9, the measurement device 900 may include a first sending module 901, a first receiving module 902, and a measurement module 903.

The first sending module 901 is adapted to sending status information to a base station. The first receiving module 902 is adapted to receiving measurement instruction information sent by the base station according to the status information. The measurement module 903 is adapted to performing measurement according to the measurement instruction information.

According to an embodiment herein, the status information may be for indicating at least one of a movement status of the UE and a channel status of the UE.

According to an embodiment herein, the measurement module 903 may be adapted to starting to perform measurement as triggered by the measurement instruction information. Further, according to an embodiment herein, the measurement module 903 may be adapted to adjusting a measurement frequency as instructed by the measurement instruction information, and performing measurement according to an adjusted measurement frequency.

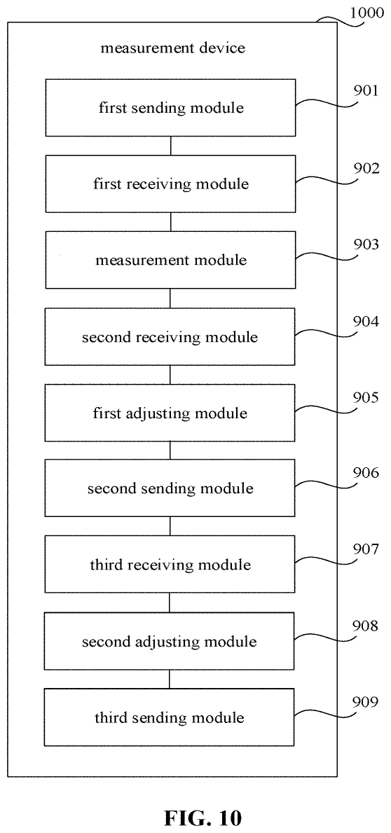

As shown in FIG. 10, an embodiment herein further provides another measurement device 1000. In addition to the modules included in the measurement device 900, the measurement device 1000 may further include a second receiving module 904, a first adjustment module 905, a second sending module 906, a third receiving module 907, a second adjustment module 908, and a third sending module 909.

The second receiving module 904 may be adapted to receiving first report instruction information sent by the base station according to the status information.

The first adjustment module 905 may be adapted to adjusting a result sending frequency for sending a result of measurement to the base station as instructed by the first report instruction information.

The second sending module 906 may be adapted to sending the result of measurement to the base station according to an adjusted result sending frequency.

The third receiving module 907 may be adapted to receiving second report instruction information sent by the base station according to the status information.

The second adjustment module 908 may be adapted to adjusting a status sending frequency for sending the status information to the base station as instructed by the second report instruction information.

The third sending module 909 may be adapted to sending the status information to the base station according to an adjusted status sending frequency.

To sum up, with a measurement device herein, a base station receives status information sent by UE. The base station sends measurement instruction information to the UE according to the status information sent by the UE. Accordingly, the UE may perform measurement according to the measurement instruction information. As a result, the base station may control, according to the status of the UE, measurement by the UE, thereby improving flexibility of measurement by the UE.

A module of the device according to at least one embodiment herein may perform an operation in a mode elaborated in at least one embodiment of the method herein, which will not be repeated here.

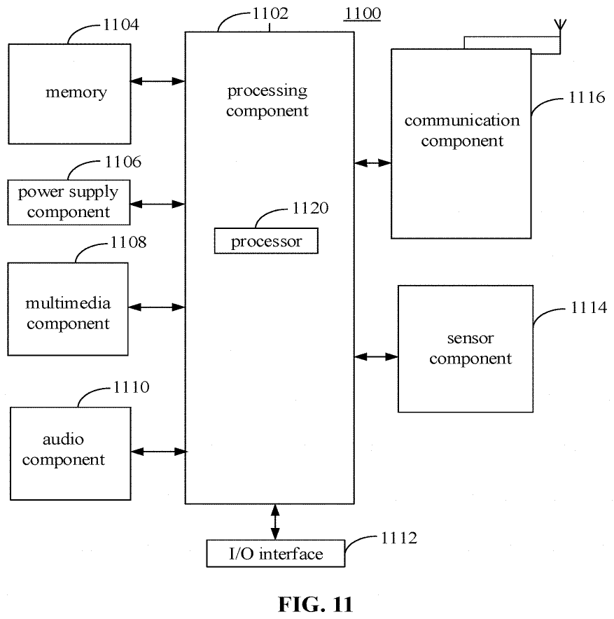

FIG. 11 is a block diagram of a device 1100 for measurement according to an exemplary embodiment. For example, the device 1100 may be a mobile phone, a computer, a digital broadcasting terminal, a message transceiver, a game console, a tablet device, a medical device, a fitness device, a Personal Digital Assistant (PDA), and the like.

Referring to FIG. 11, the device 1100 may include one or more of a processing component 1102, memory 1104, a power supply component 1106, a multimedia component 1108, an audio component 1110, an Input/Output (I/O) interface 1112, a sensor component 1114, and a communication component 1116.

The processing component 1102 generally controls an overall operation of the device 1100, such as operations associated with display, a telephone call, data communication, a camera operation, and a recording operation. The processing component 1102 may include one or more processors 1120 to execute instructions so as to complete all or some options of the method. In addition, the processing component 1102 may include one or more modules to facilitate interaction between the processing component 1102 and other components. For example, the processing component 1102 may include a multimedia module to facilitate interaction between the multimedia component 1108 and the processing component 1102.

The memory 1104 may be configured for storing various types of data to support the operation on the device 1100. Example of such data may include instructions of any application or method configured for operating on the device 1100, contact data, phonebook data, messages, pictures, videos, and/or the like. The memory 1104 may be realized by any type of transitory or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or compact disk.

The power supply component 1106 may supply electric power to various components of the device 1100. The power supply component 1106 may include a power management system, one or more power sources, and other components related to generating, managing and distributing electricity for the device 1100.

The multimedia component 1108 may include a screen providing an output interface between the device 1100 and a user. The screen may include a Liquid Crystal Display (LCD) and a Touch Panel (TP). If the screen may include a TP, the screen may be realized as a touch screen to receive an input signal from a user. The TP may include one or more touch sensors for sensing touch, slide and gestures on the TP. The touch sensors not only may sense the boundary of a touch or slide move, but also detect the duration and pressure related to the touch or slide move. The multimedia component 1108 may include a front camera and/or a rear camera. When the device 1100 is in an operation mode such as a shooting mode or a video mode, the front camera and/or the rear camera may receive external multimedia data. Each of the front camera and the rear camera may be a fixed optical lens system or may have a focal length and be capable of optical zooming.

The audio component 1110 may be configured for outputting and/or inputting an audio signal. For example, the audio component 1110 may include a microphone (MIC). When the device 1100 is in an operation mode, such as a call mode, a recording mode, and a voice recognition mode, the MIC may be configured for receiving an external audio signal. The received audio signal may be further stored in the memory 1104 or may be sent via the communication component 1116. The audio component 1110 may further include a loudspeaker configured for outputting the audio signal.

The I/O interface 1112 may provide an interface between the processing component 1102 and a peripheral interface module. Such a peripheral interface module may be a keypad, a click wheel, a button or the like. Such a button may include but is not limited to: a homepage button, a volume button, a start button, and a lock button.

The sensor component 1114 may include one or more sensors for assessing various states of the device 1100. For example, the sensor component 1114 may detect an on/off state of the device 1100 and relative location of components such as the display and the keypad of the device 1100. The sensor component 1114 may further detect a change in the location of the device 1100 or of a component of the device 1100, whether there is contact between the device 1100 and a user, the orientation or acceleration/deceleration of the device 1100, and a change in the temperature of the device 1100. The sensor component 1114 may include a proximity sensor configured for detecting existence of a nearby object without physical contact. The sensor component 1114 may further include an optical sensor such as a Complementary Metal-Oxide-Semiconductor (CMOS) or Charge-Coupled-Device (CCD) image sensor used in an imaging application. The sensor component 1114 may further include an acceleration sensor, a gyroscope sensor, a magnetic sensor, a pressure sensor, a microwave sensor, or a temperature sensor.

The communication component 1116 may be configured for facilitating wired or wireless communication between the device 1100 and other equipment. The device 1100 may access a wireless network based on any communication standard, such as WiFi, 2G or 3G, or combination thereof. The communication component 1116 may receive a broadcast signal or broadcast related information from an external broadcast management system via a broadcast channel. The communication component 1116 may further include a Near Field Communication (NFC) module for short-range communication. For example, the NFC module may be based on Radio Frequency Identification (RFID), Infrared Data Association (IrDA), Ultra-Wideband (UWB) technology, Bluetooth (BT), and other technologies.

The device 1100 may be realized by one or more of Application Specific Integrated Circuits (ASIC), Digital Signal Processors (DSP), Digital Signal Processing Device (DSPD), Programmable Logic Devices (PLD), Field Programmable Gate Arrays (FPGA), controllers, microcontrollers, microprocessors or other electronic components to implement a technical process executed by UE20 in an method embodiment herein.

A non-transitory computer-readable storage medium including instructions, such as memory 1104 including instructions, may be provided. The instructions may be executed by the processor 1120 of the device 1100 to implement a technical process executed by UE20 in an method embodiment herein. For example, the non-transitory computer-readable storage medium may be a Read-Only Memory (ROM), a Compact Disc Read-Only Memory (CD-ROM), a magnetic tape, a floppy disk, optical data storage equipment, and the like.

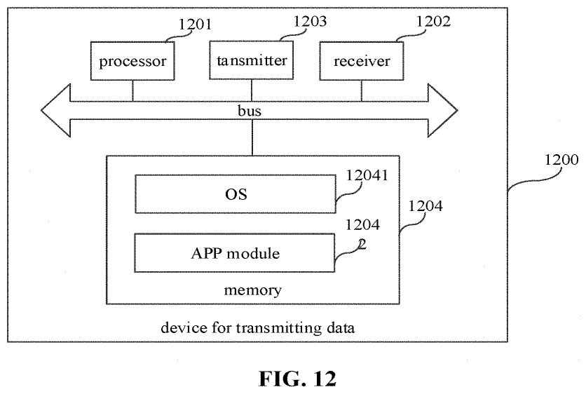

FIG. 12 is a block diagram of a measurement device 1200 according to an exemplary embodiment. For example, the measurement device 1200 may be a base station. As shown in FIG. 12, the measurement device 1200 may include a processor 1201, a receiver 1202, a transmitter 1203, and memory 1204. The receiver 1202, the transmitter 1203, and the memory 1204 may be connected respectively to the processor 1201 through a bus.

The processor 1201 may include one or more processing cores. By running a software program, a module, and the like, the processor 1201 may execute a method executed by a base station in a measurement method herein. The memory 1204 may be adapted to storing a software program, a module, and the like. The memory 1204 may store an operating system 12041, at least one application module 12042 required by a function, etc. The receiver 1202 may be adapted to receiving communication data sent by other equipment. The transmitter 1203 may be adapted to sending communication data to other equipment.

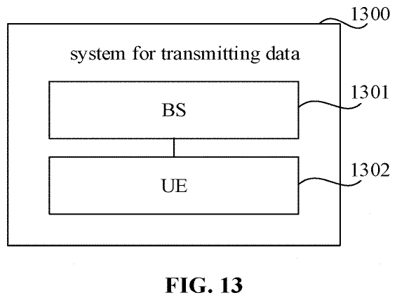

FIG. 13 is a block diagram of a measurement system 1300 according to an exemplary embodiment. As shown in FIG. 13, the measurement system 1300 may include a base station 1301 and UE 1302.

The base station 1301 may be adapted to executing a measurement method executed by a base station according to an embodiment shown in FIG. 4.

The UE 1302 may be adapted to executing a measurement method executed by UE according to an embodiment shown in FIG. 4.

A computer-readable storage medium may be provided. The computer-readable storage medium may be non-transitory computer-readable storage medium. The computer-readable storage medium may include a computer program. When executed by a processing component, the computer program may implement a measurement method herein.

The embodiment herein further provides a computer program product, having stored therein instructions which, when executed on a computer, allow the computer to execute a measurement method herein.

The embodiment herein further provides a chip including a programmable logic circuit and/or program instructions. When run, the chip may execute a measurement method herein.

An associating conjunction herein is used to indicate three logical associations. For example, by A and/or B, it may mean that there are three logical associations, namely, existence of but A, existence of but B, or existence of both A and B.

Other implementations of the subject disclosure will be apparent to a person having ordinary skill in the art that has considered the specification and or practiced the subject disclosure. The subject disclosure is intended to cover any variation, use, or adaptation of the subject disclosure following the general principles of the subject disclosure and including such departures from the subject disclosure as come within common knowledge or customary practice in the art. The specification and the embodiments are intended to be exemplary only, with a true scope and spirit of the subject disclosure being indicated by the appended claims.

The subject disclosure is not limited to the exact construction that has been described above and illustrated in the accompanying drawings, and that various modifications and changes can be made to the subject disclosure without departing from the scope of the subject disclosure. It is intended that the scope of the subject disclosure is limited only by the appended claims.

1. A measurement method, comprising:
receiving status information sent by User Equipment (UE); and
sending measurement instruction information to the UE based on the status information sent by the UE,
wherein the measurement instruction information is for instructing instructs the UE to perform measurement based on the measurement instruction information.

2. The method of claim 1, wherein the status information indicates at least one of a movement status of the UE and a channel status of the UE.

3. The method of claim 1, wherein the measurement instruction information triggers measurement by the UE.

4. The method of claim 1, wherein the measurement instruction information instructs the UE to adjust a measurement frequency and perform measurement based on the adjusted measurement frequency.

5. The method of claim 1, further comprising:
sending first report instruction information to the UE based on the status information sent by the UE,
wherein the first report instruction information instructs the UE to adjust a result sending frequency for sending a result of measurement to a base station and send the result of measurement to the base station based on the adjusted result sending frequency.

6. The method of claim 1, further comprising:
sending second report instruction information to the UE based on the status information sent by the UE,
wherein the second report instruction information instructs the UE to adjust a status sending frequency for sending the status information to a base station and send the status information to the base station based on the adjusted status sending frequency.

7. A measurement method, comprising:
sending status information to a base station;
receiving measurement instruction information sent by the base station based on the status information; and
performing measurement based on the measurement instruction information.

8. The method of claim 7, wherein the status information is for indicating at least one of a movement status of User Equipment (UE) and a channel status of the UE.

9. The method of claim 7, wherein performing measurement based on the measurement instruction information further comprises:
starting to perform measurement as triggered by the measurement instruction information.

10. The method of claim 7, wherein performing measurement based on the measurement instruction information further comprises:
adjusting a measurement frequency as instructed by the measurement instruction information; and
performing measurement an based on the adjusted measurement frequency.

11. The method of claim 7, further comprising:
receiving first report instruction information sent by the base station based on the status information;
adjusting a result sending frequency for sending a result of measurement to the base station as instructed by the first report instruction information; and
sending the result of measurement to the base station based on an adjusted result sending frequency.

12. The method of claim 7, further comprising:
receiving second report instruction information sent by the base station based on the status information;
adjusting a status sending frequency for sending the status information to the base station as instructed by the second report instruction information; and
sending the status information to the base station based on an adjusted status sending frequency.

13-24. (canceled)

25. A base station, comprising a processor and memory
that stores an instruction that, when executed by the processor,
causes the processor to
implement the method of claim 1.

26. User equipment, comprising a processor and memory
that stores an instruction that when executed by the processor
causes the processor to perform an operation comprising:
sending status information to a base station;
receiving measurement instruction information sent by the base station based on the status information; and
performing measurement based on the measurement instruction information.

27-28. (canceled)

29. The user equipment of claim 26, wherein the status information indicates at least one of a movement status of User Equipment (UE) and a channel status of the UE.

30. The user equipment of claim 26, wherein the processor performs the operation further comprising:
starting to perform measurement as triggered by the measurement instruction information.

31. The user equipment of claim 26, wherein the processor performs the operation further comprising:
adjusting a measurement frequency as instructed by the measurement instruction information; and
performing measurement based on the adjusted measurement frequency.

32. The user equipment of claim 26, wherein the processor performs the operation further comprising
receiving first report instruction information sent by the base station based on the status information;
adjusting a result sending frequency for sending a result of measurement to the base station as instructed by the first report instruction information; and
sending the result of measurement to the base station based on the adjusted result sending frequency.

33. The user equipment of claim 26, wherein the processor performs the operation further comprising:
receiving second report instruction information sent by the base station based on the status information;
adjusting a status sending frequency for sending the status information to the base station as instructed by the second report instruction information; and
sending the status information to the base station based on the adjusted status sending frequency.
